(19) United States
(12) Patent Application Publication
(10) Pub. No.: US 2026/0307262 A1
(43) Pub. Date: Oct. 8, 2026

(54) SYSTEM FOR REAL-TIME PRECISION CALIBRATION OF ROBOTS BASED ON MACHINE VISION

(71) Applicant: BRILS Co., Ltd., Incheon (KR)

(72) Inventor: Jin JEON, Incheon (KR)

(21) Appl. No.: 19/638,317

(22) Filed: Apr. 3, 2026

(30) Foreign Application Priority Data
Apr. 7, 2025 (KR) 10-2025-0044499

(51) Int. Cl. B25J 9/16; B25J 13/08; B25J 19/02

(52) U.S. Cl. CPC B25J 9/1692; B25J 9/161; B25J 9/163; B25J 9/1653; B25J 9/1697; B25J 13/089; B25J 19/022

(57) ABSTRACT

A robot calibration system includes a machine vision sensor connected to an end effector of a robot, a memory storing computer-executable instructions, and a processor configured to access the memory, execute the computer-executable instructions, and control the robot. When a state of the robot is identified as performing a predetermined task, the processor acquires, from the machine vision sensor, first position data regarding a task position required for the robot to perform the predetermined task, acquires, based on the first position data, second position data regarding a position of the robot from a controller controlling the robot, and determines a position error regarding an error between the first position data and the second position data.

### CROSS REFERENCE TO RELATED APPLICATION

The present application claims priority to Korean Patent Application No. 10-2025-0044499, filed Apr. 7, 2025, the entire contents of which are incorporated here for all purposes by this reference.

### TECHNICAL FIELD

The present disclosure relates to a system for real-time precision calibration of robots based on machine vision, and more particularly, to a technique for improving positional accuracy of collaborative robots and industrial robots.

### BACKGROUND

Robots are used in various industrial fields such as manufacturing, assembly, inspection, and packaging, and accuracy and repeatability of operations are important factors that determine robot performance. In particular, in complex work processes, accurate position control based on a kinematic model of a robot is essential, and calibration techniques for robots are widely used for this purpose.

Conventional robot calibration techniques are generally performed using high-precision external measurement equipment such as a laser tracker, an optical measurement device, or a coordinate measuring machine (CMM). Although such methods can provide high accuracy, such methods have fundamental limitations in that installation and alignment of the measurement equipment are complicated, specialized operators are required, and correction cannot be performed in real time while a robot is actually operating because the methods are offline-based methods.

In addition, such expensive measurement equipment entails very high introduction costs, and, due to periodic maintenance and environmental constraints (e.g., vibration, lighting, and the need for precise arrangement), is difficult to apply in ordinary manufacturing environments. As a result, calibration work is performed only periodically or manually to a limited extent, and it is difficult to respond immediately to positional errors that may occur during actual operation or accumulated errors in a kinematic model.

Accordingly, there is a need to develop a system capable of detecting positional errors in real time and automatically correcting the positional errors during operation of a robot without using external measurement equipment.

### SUMMARY

An object of the present disclosure is to provide a robot calibration system capable of improving positional accuracy of a robot by measuring a position error through a machine vision sensor mounted on an end effector of the robot and correcting a DH parameter by using a self-correcting metaheuristic optimization algorithm, without using precision measurement equipment such as an expensive laser tracker or a coordinate measuring machine, and capable of performing precision robot calibration without establishment of external infrastructure, thereby reducing equipment costs.

Another object of the present disclosure is to provide a robot calibration system including an algorithm structure capable of correcting, in real time, a measured position error when the position error occurs due to external environmental changes, such as mechanical deformation, temperature, or humidity, which may occur as a robot is used for a long period of time, thereby securing robustness against dynamic environmental changes, maintaining precision and stability of a robot system over a long period of time, and providing a high-precision automated process.

Another object of the present disclosure is to provide a robot calibration system capable of reducing burdens associated with installation space and maintenance personnel by integrating a real-time precision correction function into an internal system of a robot, stably maintaining robot operation without continuous manual correction work, significantly improving operational efficiency and economic feasibility of the robot system, and expanding applicability and industrial utility in various fields including precision manufacturing, a smart factory, and a medical robot.

Objects of the present disclosure are not limited to those described above, and other objects not described herein will be clearly understood by those skilled in the art from the following description.

In order to achieve the above-described objects, according to one aspect of the present disclosure, there is provided a robot calibration system including a machine vision sensor connected to an end effector of a robot, a memory storing computer-executable instructions, and a processor configured to access the memory, execute the computer-executable instructions, and control the robot, wherein the processor is configured to, when a state of the robot is identified as performing a predetermined task, acquire, from the machine vision sensor, first position data regarding a task position required for the robot to perform the predetermined task, based on acquiring the first position data, acquire, from a controller controlling the robot, second position data regarding a position of the robot, determine a position error regarding an error between the first position data and the second position data, at a first time point at which the position error is determined, identify a first DH parameter (Denavit-Hartenberg parameter) regarding a positional relationship between a joint and a link of the end effector, apply the first DH parameter to a calibration model trained to minimize the position error, thereby acquiring a second DH parameter at a second time point subsequent to the first time point, and control a position of the end effector by applying the second DH parameter to the controller.

In an embodiment, the machine vision sensor may determine the first position data based on a reference marker included in a space in which the robot performs the task or an external object that is a target of the task.

In an embodiment, the processor may identify the first DH parameter based on at least one of a link length, a link twist, a joint offset, a joint angle, or a combination thereof.

In an embodiment, the processor may identify a metaheuristic optimization algorithm including at least one of a Differential Evolution (DE) algorithm, a Particle Swarm Optimization (PSO) algorithm, an Artificial Bee Colony (ABC) algorithm, a Gravitational Search Algorithm (GSA), or a combination thereof, and may perform training of the calibration model based on the metaheuristic optimization algorithm, an amount of change in the first DH parameter during a predetermined time interval, and a predetermined learning rate.

In an embodiment, the processor may perform communication with the robot based on at least one of Ethernet, Universal Serial Bus (USB), Modbus, Controller Area Network (CAN) communication, or a combination thereof, may acquire terrain information of a space in which the robot performs the task through a LiDAR sensor included in the robot, and may perform verification of the first position data by applying the first position data acquired from the machine vision sensor to the terrain information acquired from the LiDAR sensor.

According to at least one embodiment of the present disclosure, positional accuracy of a robot may be improved by measuring a position error through a machine vision sensor mounted on an end effector of the robot and correcting a DH parameter by using a self-correcting metaheuristic optimization algorithm, without using precision measurement equipment such as an expensive laser tracker or a coordinate measuring machine, and precision robot calibration may be performed without establishment of external infrastructure, thereby reducing equipment costs.

According to at least one embodiment of the present disclosure, when a position error occurs due to an external environmental change, such as mechanical deformation, temperature, or humidity, which may occur as the robot is used for a long period of time, robustness against dynamic environmental changes may be secured by including an algorithm structure capable of correcting the measured position error in real time, precision and stability of a robot system may be maintained over a long period of time, and a high-precision automated process may be provided.

According to at least one embodiment of the present disclosure, by integrating a real-time precision correction function into an internal system of the robot, burdens associated with installation space and maintenance personnel may be reduced, robot operation may be stably maintained without continuous manual correction work, operational efficiency and economic feasibility of the robot system may be significantly improved, and applicability and industrial utility in various fields including precision manufacturing, a smart factory, and a medical robot may be expanded.

In addition to the foregoing, various effects directly or indirectly understood from the present document may be provided.

### BRIEF DESCRIPTION OF THE DRAWINGS

FIG. 1 is a block diagram illustrating a robot calibration system according to an embodiment of the present disclosure.

FIG. 2 is a flowchart for explaining a robot calibration method according to an embodiment of the present disclosure.

FIG. 3 is a diagram for explaining a method of controlling a position of an end effector based on a machine vision sensor in a robot calibration system according to an embodiment of the present disclosure.

FIG. 4 is a diagram for explaining a position error and a calibration model in a robot calibration system according to an embodiment of the present disclosure.

FIG. 5 is a diagram illustrating a graph regarding a position error in controlling a position of an end effector based on a first DH parameter in a robot calibration system according to an embodiment of the present disclosure.

FIG. 6 is a diagram illustrating a graph regarding a position error in controlling a position of an end effector based on a second DH parameter in a robot calibration system according to an embodiment of the present disclosure.

FIG. 7 is a diagram illustrating a graph regarding a difference between the position error illustrated in FIG. 5 and the position error illustrated in FIG. 6 in a robot calibration system according to an embodiment of the present disclosure.

FIG. 8 is a diagram illustrating a graph regarding a reduction amount of a position error in controlling a position of an end effector based on a second DH parameter in a robot calibration system according to an embodiment of the present disclosure.

### DETAILED DESCRIPTION

Hereinafter, certain embodiments of the present disclosure will be described in detail with reference to the accompanying drawings. In assigning reference numerals to components of the drawings, it should be noted that like components are designated by like reference numerals whenever possible even though they are illustrated in different drawings. In addition, when it is determined that a detailed description of a related known configuration or function may unnecessarily obscure the subject matter of the embodiments of the present disclosure, the detailed description thereof will be omitted. In particular, various embodiments of the present document are described with reference to the accompanying drawings. However, this is not intended to limit the technology described in the present document to specific embodiments, and it should be understood that the present disclosure includes various modifications, equivalents, and/or alternatives of the embodiments described herein. With respect to description of the drawings, similar reference numerals may be used for similar components.

In describing components of embodiments of the present disclosure, terms such as first, second, A, B, (a), and (b) may be used. These terms are used only to distinguish one component from another component, and the nature, order, or sequence of the corresponding component is not limited by these terms. Unless otherwise defined, all terms used herein, including technical or scientific terms, have the same meanings as commonly understood by one of ordinary skill in the art to which the present disclosure belongs. Terms defined in generally used dictionaries should be construed as having meanings consistent with their meanings in the context of the related art, and should not be construed in an idealized or excessively formal sense unless expressly defined otherwise in the present application. For example, expressions such as “first,” “second,” “firstly,” or “secondly,” as used in the present document, may modify various components regardless of order and/or importance, and are used only to distinguish one component from another component without limiting the components. For example, a first user device and a second user device may indicate different user devices regardless of order or importance. For example, without departing from the scope of the claims described in the present document, a first component may be referred to as a second component, and similarly, a second component may be referred to as a first component.

As used herein, expressions such as “include,” “may include,” “comprise,” or “may comprise” indicate the presence of corresponding features (e.g., numbers, functions, operations, or components such as parts), and do not preclude the presence of one or more additional features.

When a component (e.g., a first component) is referred to as being “operatively or communicatively coupled with/to” or “connected to” another component (e.g., a second component), it should be understood that the component may be directly connected to the other component or may be connected thereto through another component (e.g., a third component). On the other hand, when a component (e.g., a first component) is referred to as being “directly connected to” or “directly coupled to” another component (e.g., a second component), it may be understood that no other component (e.g., a third component) is present between the component and the other component.

As used herein, the expression “configured to” may be interchangeably used, depending on the context, with, for example, “suitable for,” “having the capacity to,” “designed to,” “adapted to,” “made to,” or “capable of.” The term “configured to” may not necessarily mean only “specifically designed to” in terms of hardware. Rather, in some situations, the expression “a device configured to” may mean that the device is capable of performing an operation together with another device or component. For example, the phrase “a processor configured to perform A, B, and C” may mean a dedicated processor (e.g., an embedded processor) for performing the corresponding operations, or a generic-purpose processor (e.g., a CPU or an application processor) capable of performing the corresponding operations by executing one or more software programs stored in a memory device.

Terms used herein are only for describing certain embodiments and are not intended to limit other embodiments. Singular expressions may include plural expressions unless the context clearly indicates otherwise. Technical or scientific terms used herein have the same meanings as commonly understood by one of ordinary skill in the art in the technical field described in the present document. Terms defined in generally used dictionaries may be construed as having the same or similar meanings as their contextual meanings in the related art, and, unless expressly defined in the present document, should not be construed in an idealized or excessively formal sense. In some cases, even terms defined in the present document should not be construed to exclude embodiments of the present document.

As used herein, expressions such as “A or B,” “at least one of A and/or B,” or “one or more of A and/or B” may include all possible combinations of the listed items. For example, “A or B,” “at least one of A and B,” or “at least one of A or B” may indicate all of: (1) including at least one A, (2) including at least one B, or (3) including both at least one A and at least one B. Further, in describing components of embodiments of the present disclosure, each of the phrases such as “A or B,” “at least one of A and B,” “at least one of A or B,” “A, B or C,” “at least one of A, B and C,” “at least one of A, B, or C,” and “at least one of A, B, C, or any combination thereof” may include any one of the items listed together in the corresponding phrase, or all possible combinations thereof. In particular, the phrase “at least one of A, B, C, or any combination thereof” may include A, B, C, or a combination thereof, such as AB or ABC.

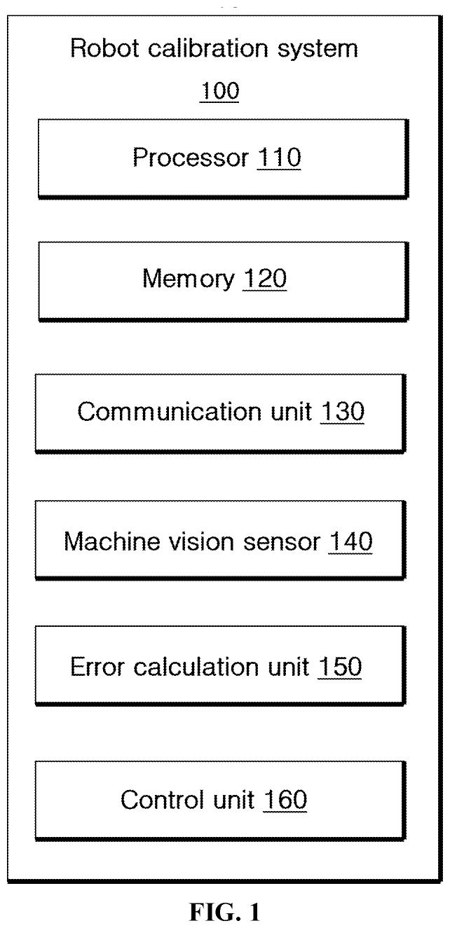

Hereinafter, embodiments of the present disclosure will be described in detail with reference to FIGS. 1 to 8.

FIG. 1 is a block diagram illustrating a robot calibration system according to an embodiment of the present disclosure.

A robot calibration system 100 according to an embodiment may include a processor 110, a memory 120 including instructions, a communication unit 130, a machine vision sensor 140, an error calculation unit 150, and a control unit 160.

For example, the robot calibration system 100 may refer to a system for controlling a position of an end effector of a robot and correcting a DH parameter so as to minimize a position error of the robot. For example, the robot calibration system 100 is a self-correcting system that continuously maintains and improves positional accuracy of the robot by measuring, in real time during an operation, a position of the robot through the machine vision sensor 140 attached to the end effector of the robot and automatically correcting the DH parameter based on an error from position information calculated by a controller.

For example, the robot calibration system 100 may actively respond to accumulated errors over time, mechanical deformation, or changes in an external environment through a calibration model trained by a metaheuristic optimization algorithm for error correction. Through this, the robot calibration system 100 may continuously maintain and improve positional accuracy of the robot without external measurement equipment.

For example, the processor 110 may execute software and control at least one other component connected to the processor 110 (e.g., a hardware component or a software component). The processor 110 may also perform various data processing or calculations. For example, the processor 110 may store first position data, second position data, a position error, a first DH parameter, or a second DH parameter in the memory 120.

For reference, the processor 110 may perform all operations performed by the robot calibration system 100. Therefore, for convenience of description, operations performed by the robot calibration system 100 are mainly described herein as operations performed by the processor 110. In addition, although the processor 110 is mainly described herein as a single processor for convenience of description, the present disclosure is not limited thereto. For example, the robot calibration system 100 may include processors, and each of the processors may perform all operations related to correcting the DH parameter so as to minimize the position error of the robot.

For example, the memory 120 may temporarily and/or permanently store various data and/or information required for performing an operation of correcting the DH parameter so as to minimize the position error of the robot. For example, the memory 120 may store the first position data, the second position data, the position error, the first DH parameter, or the second DH parameter.

For example, the communication unit 130 may support communication between the robot calibration system 100 and an external server. The communication unit 130 may include one or more components enabling communication between the robot calibration system 100 and the external server. Specifically, the communication unit 130 may include a short-range wireless communication unit, a microphone, and the like. Here, short-range communication technologies may include, for example, wireless LAN (Wi-Fi), Bluetooth, ZigBee, Wi-Fi Direct (WFD), ultra-wideband (UWB), infrared data association (IrDA), Bluetooth Low Energy (BLE), or Near Field Communication (NFC), but are not limited thereto. The processor 110 may perform communication with the robot based on at least one of Ethernet, Universal Serial Bus (USB), Modbus, Controller Area Network (CAN) communication, or a combination thereof, included in the communication unit 130.

For example, the machine vision sensor 140 may refer to a sensor attached to the end effector of the robot. Specifically, the machine vision sensor 140 may be attached to the end effector of the robot to visually recognize an operation performed by the robot in a workspace and acquire, in real time, image-based three-dimensional position data regarding a current position of the robot.

For example, the error calculation unit 150 may refer to a configuration for calculating, according to an equation, an error between position information measured in real time from the machine vision sensor 140 and position information from a controller of the robot. Specifically, the error calculation unit 150 may refer to a calculation module for calculating the position error of the robot according to a mathematical equation based on a difference between the first position data received from the machine vision sensor 140 and the second position data acquired from the controller of the robot.

For example, the control unit 160 may refer to a configuration for continuously correcting positional accuracy of the robot by reflecting an optimized DH parameter to a controller (or a control system) of the robot. Specifically, the control unit 160 may be a configuration for immediately reflecting an updated DH parameter, which is updated to minimize the position error, to the control system of the robot to control the position of the end effector so that the end effector of the robot can reach a target position more precisely.

For example, a computing system related to the robot calibration system 100 may include at least one processor 110, the memory 120, a user interface input device, a user interface output device, storage, and a network interface, which are connected through a bus (BUS). For example, the processor 110 may be a semiconductor device for executing processing of instructions stored in a central processing unit (CPU) or in the memory 120 and/or the storage. The memory 120 and the storage may include various types of volatile or non-volatile storage media. For example, the memory 120 may include a read-only memory (ROM) and a random-access memory (RAM).

Accordingly, steps of methods or algorithms described in connection with the embodiments disclosed herein may be directly implemented by hardware, a software module executed by the processor 110, or a combination of the two. The software module may reside in a storage medium (i.e., the memory 120 and/or the storage), such as a RAM memory, a flash memory, a ROM memory, an EPROM memory, an EEPROM memory, a register, a hard disk, a removable disk, or a CD-ROM. An exemplary storage medium may be coupled to the processor 110 such that the processor 110 may read information from and write information to the storage medium. Alternatively, the storage medium may be integral with the processor 110. The processor 110 and the storage medium may reside in an application-specific integrated circuit (ASIC). The ASIC may reside in a user terminal. Alternatively, the processor 110 and the storage medium may reside as discrete components in a user terminal.

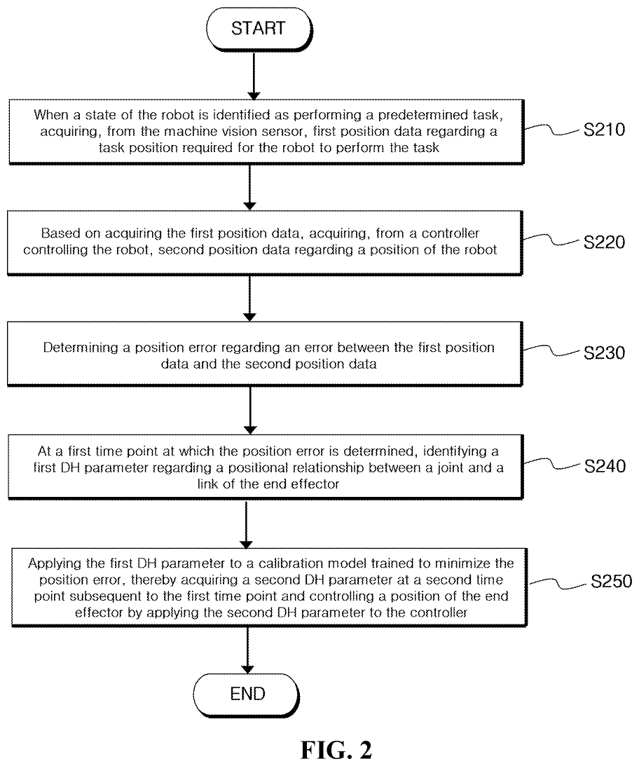

FIG. 2 is a flowchart for explaining a robot calibration method according to an embodiment of the present disclosure.

In operation S210, the processor (e.g., the processor 110 of FIG. 1) according to an embodiment may, when a state of the robot is identified as performing a predetermined task, acquire, from the machine vision sensor (e.g., the machine vision sensor 140 of FIG. 1), first position data regarding a task position required for the robot to perform the task.

For example, the state of the robot may include internal state information indicating whether the robot is executing an operation mode, a position, a posture, a speed, an acceleration, and an operation command at a specific point in time. The state of the robot may be used as reference information for determining whether the robot is performing a specific task, and may be used as a trigger condition under which the processor identifies a task-performing state.

For example, the predetermined task may be an operation sequence or task plan defined in advance for the robot to perform, and may include functional units such as movement along a specific path, object manipulation, assembly, and inspection.

For example, the first position data may be data regarding an actual position of the robot acquired from the machine vision sensor, and may indicate measured position information including coordinates in a space in which the robot is currently located.

In operation S220, the processor may, based on acquiring the first position data, acquire, from a controller that controls the robot, second position data regarding a position of the robot.

For example, the controller of the robot may refer to hardware or a software module that performs interpretation of instructions for controlling an operation of the robot, kinematic calculation, path generation, or motion control.

For example, the second position data may be information regarding a position of the robot acquired from the controller of the robot, and may indicate theoretical or target position information of the robot calculated based on a kinematic model and an instruction. The second position data may be compared with actual position data measured by the machine vision sensor, that is, the first position data, and may be used to determine a position error.

For reference, as used herein, “kinematics” may refer to mathematically calculating a position and a posture of an end portion (e.g., an end effector) of a robot based on a geometric relationship between joints and links of the robot, or deriving joint angles required to achieve a specific position.

In operation S230, the processor may determine a position error regarding an error between the first position data and the second position data.

For example, the position error may be a physical distance indicating a difference between an actual position measured by the machine vision sensor, that is, the first position data, and a target position calculated by the controller of the robot, that is, the second position data, when the robot moves to a specific task position, and may indicate a reference value for quantitatively determining precision of the robot and a need for position correction. Specifically, the position error may be calculated based on a coordinate difference in a three-dimensional space.

For example, the position error may be expressed by a three-dimensional Euclidean distance equation, such as Equation 1 below:

$$e = \sqrt{{( x - {x}^{′} )}^{2} + {( y - {y}^{′} )}^{2} + {( z - {z}^{′} )}^{2}} \qquad [ Equation 1 ]$$

Here, the first position data may be denoted by [variable], and the second position data may be denoted by [variable]. The position error may indicate that, as a difference between the first position data and the second position data becomes larger, an error between an actual operation of the robot and a control model becomes larger.

In operation S240, the processor may identify, at a first time point at which the position error is determined, a first DH parameter (Denavit-Hartenberg parameter) regarding a positional relationship between a joint and a link of the end effector.

For example, the first time point may indicate a point in time at which, while the robot is performing the predetermined task, an actual position, that is, the first position data, is collected through the machine vision sensor and the position error between the actual position and a position calculated by the controller, that is, the second position data, is determined.

For example, the first DH parameter may be a parameter set mathematically representing a kinematic configuration of the robot at the first time point, that is, a relative positional relationship between joints and links, and may indicate an initial value of the Denavit-Hartenberg parameter used for calculation of a position of the robot at the first time point. Specifically, the first DH parameter may be used as an original value or a reference value reflecting a state of the robot at a point in time at which the position error occurs.

In operation S250, the processor may apply the first DH parameter to a calibration model trained to minimize the position error, thereby acquiring a second DH parameter at a second time point subsequent to the first time point, and may control a position of the end effector by applying the second DH parameter to the controller.

For example, the calibration model may refer to a mathematical model or optimization structure that adjusts a DH parameter of the robot in a learning-based manner to minimize the position error. Specifically, the calibration model may receive the position error, the first DH parameter, and a learning rate as inputs and output a corrected DH parameter, that is, the second DH parameter, to reduce the position error. As described herein, the calibration model may include a metaheuristic optimization algorithm (e.g., DE, PSO, ABC, and GSA), and may be configured to dynamically update the DH parameter in real time according to the position error.

For example, the processor may train the calibration model. Illustratively, the calibration model may include a neural network. The neural network may include a plurality of layers, and each layer may include a plurality of nodes. Each node may have a node value determined based on an activation function. A node of any layer may be connected to a node of another layer (e.g., another node) through a link (e.g., a connection edge) having a connection weight. A node value of a node may be propagated to other nodes through the link. In an inference operation of the neural network, node values may be forward propagated from a previous layer toward a next layer.

For example, in the calibration model, a forward propagation operation may refer to an operation of propagating, from an input layer toward an output layer of the calibration model, node values based on input data. That is, a node value of a node may be propagated (e.g., forward propagated) to a node of a next layer (e.g., a next node) connected through a node and a link. For example, the node may receive, from previous nodes (e.g., a plurality of nodes) connected through connection lines, weighted values weighted by connection weights.

For example, a node value of the node may be determined based on application of an activation function to a sum of weighted values received from previous nodes (e.g., a weighted sum). Parameters of the neural network may illustratively include the above-described connection weights. The parameters of the neural network may be updated such that an objective function value described later is changed in a targeted direction (e.g., a direction in which a loss is minimized).

For example, a trained calibration model may refer to a model trained through machine learning, and may be a trained machine learning model that outputs second DH parameter from training inputs (e.g., the position error, the first DH parameter, and the learning rate).

For example, a machine learning model (e.g., the trained calibration model) may be generated through machine learning. A learning algorithm may include, for example, supervised learning, unsupervised learning, semi-supervised learning, or reinforcement learning, but is not limited to the foregoing examples.

For example, in the case of supervised learning, the machine learning model described above may be trained based on training data including pairs of training inputs and training outputs mapped to the training inputs. For example, the machine learning model may be trained to output a training output from a training input. During training, the machine learning model may generate a temporary output in response to the training input, and may be trained such that a loss between the temporary output and the training output (e.g., a training target) is minimized. During the training process, parameters of the machine learning model (e.g., connection weights between nodes/layers in a neural network) may be updated according to the loss. Such training may be performed, for example, in the robot calibration system itself in which the machine learning model is executed, or may be performed through a separate server. The machine learning model for which training has been completed (e.g., the trained calibration model) may be stored in a memory (e.g., the memory 120 of FIG. 1).

For example, the second time point may indicate a point in time at which, after the position error is calculated at the first time point and the second DH parameter corrected by the calibration model to minimize the position error is acquired, the second DH parameter is reflected in control of the robot.

For example, the second DH parameter may indicate a new parameter set updated, based on the first DH parameter (or by correcting the first DH parameter), in a direction that minimizes the position error through the calibration model. The second DH parameter may be expressed by Equation 2 below:

$${θ}_{t + 1} = {θ}_{t} + α \times Δ {θ}_{t} \qquad [ Equation 2 ]$$

Here, [variable] may indicate the first DH parameter, [variable] may indicate the learning rate, [variable] may indicate an amount of change in a parameter, and [variable] may indicate the second DH parameter.

For example, the second DH parameter may be calculated by the calibration model, and specifically, may be mathematically calculated through Equation 2 included in the calibration model.

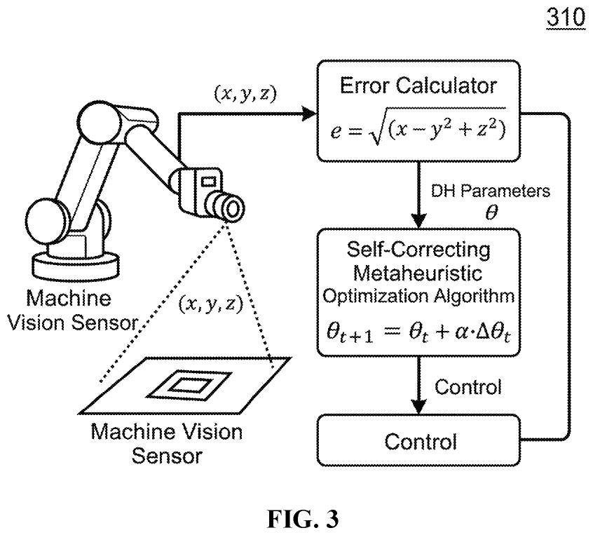

FIG. 3 is a diagram for explaining a method of controlling a position of an end effector based on a machine vision sensor in a robot calibration system according to an embodiment of the present disclosure.

FIG. 3 illustrates a process in which, in a robot calibration system 310 according to an embodiment of the present disclosure, a position of an end effector of a robot is measured in real time using a machine vision sensor, a position error is calculated, and a DH parameter is updated through an algorithm, thereby continuously maintaining and improving positional accuracy of the robot.

As illustrated in FIG. 3, the machine vision sensor at an end portion of a robot arm may recognize an image of a reference marker or an image of an external target and may measure first position data in real time. The first position data may be compared with target position data calculated through a controller of the robot or a kinematic model, and may be used to determine a position error.

For example, the machine vision sensor may determine the first position data based on a reference marker included in a space in which the robot performs a task or an external object that is a target of the task.

For example, the reference marker may indicate a fixed reference point used to measure or correct a current position of the robot, such as a geometric pattern, a QR code, a grid, or a dot array installed in a workspace so as to be visually recognizable by the machine vision sensor.

For example, the external object that is a target of the task may indicate an external object or structure on which the robot actually performs an operation, processing, or inspection, may include a feature visually recognizable by the machine vision sensor, and may be an object used for determining an operation position of the robot. Specifically, the external object may include an assembly target part, an attachment target surface, or an inspection target product.

For example, the processor may acquire, in real time, terrain information or a 3D environmental map of a space in which the robot performs a task from a LiDAR sensor included in the robot. The LiDAR sensor may measure positions and shapes of a floor surface, an obstacle, a reference surface, and a surrounding structure in the workspace through distance-based laser scanning, and may configure, based thereon, a reference frame in a space in which the robot is located.

For example, based on the terrain information acquired from the LiDAR sensor, the processor may verify logical and geometric consistency of the first position data by aligning the first position data collected from the machine vision sensor on a terrain coordinate system. Specifically, the processor may detect and correct an abnormal position measurement result caused by a sensor malfunction, a recognition error, or a change in illumination by comparing whether a position of the reference marker or a position of a task target recognized by the machine vision sensor matches an actual position on a space model generated based on LiDAR.

For example, with respect to an environmental factor that is difficult to detect by the machine vision sensor alone, such as a lighting change, reflection, or object occlusion, the processor may improve reliability of position detection of the entire system by performing redundant validation using an independent distance-based measurement function of the LiDAR sensor.

For example, the terrain information acquired from the LiDAR sensor may be used, after the second time point, for path planning of the robot, collision avoidance in the workspace, or global registration of a positional reference.

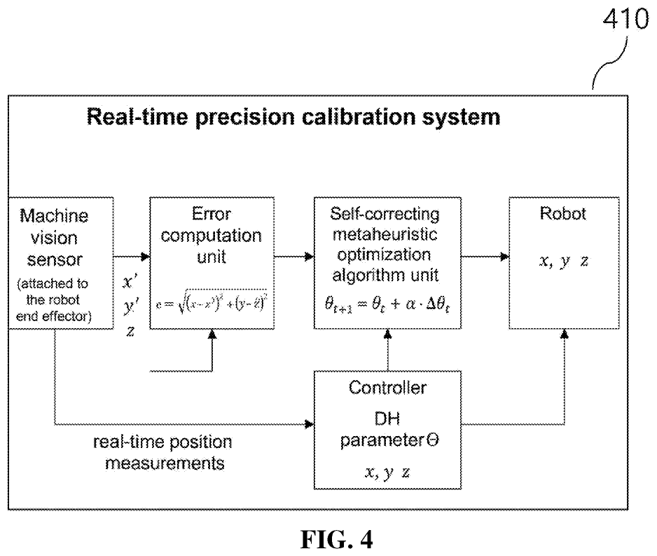

FIG. 4 is a diagram for explaining a position error and a calibration model in a robot calibration system according to an embodiment of the present disclosure.

FIG. 4 illustrates an internal configuration and an operation flow of a robot calibration system 410 according to an embodiment of the present disclosure. Specifically, FIG. 4 is a diagram for explaining a configuration of a calibration model and a data flow for calculating a position error between actual position information acquired through a machine vision sensor and controller-based position information and automatically correcting a DH parameter so as to minimize the position error.

For example, the processor (e.g., the processor 110 of FIG. 1) may identify the first DH parameter based on at least one of a link length, a link twist, a joint offset, a joint angle, or a combination thereof.

For example, the processor may identify a metaheuristic optimization algorithm including at least one of a Differential Evolution (DE) algorithm, a Particle Swarm Optimization (PSO) algorithm, an Artificial Bee Colony (ABC) algorithm, a Gravitational Search Algorithm (GSA), or a combination thereof. The processor may perform training of the calibration model based on the metaheuristic optimization algorithm, an amount of change in the first DH parameter during a predetermined time interval, and a predetermined learning rate.

For example, the Differential Evolution algorithm may be an evolutionary algorithm suitable for a real-number-based optimization problem, and may be an algorithm that improves a solution population by generating a new solution using a difference vector between individuals and repeatedly performing crossover and selection processes.

For example, the Particle Swarm Optimization algorithm may be a swarm-intelligence-based algorithm that mimics movement of a flock of birds or a school of fish, and may be an algorithm that searches for an optimal solution by regarding each candidate solution as a particle and adjusting a movement path by reflecting experience of an individual particle and an optimal solution within a swarm.

For example, the Artificial Bee Colony algorithm may be an optimization technique based on food searching and sharing behavior of bees, and may be an algorithm that searches for an optimal solution while maintaining a balance between exploration and exploitation through roles of an employed bee, an onlooker bee, and a scout bee.

For example, the Gravitational Search Algorithm may be an algorithm inspired by Newton's law of universal gravitation, and may be an algorithm that performs optimization by regarding each solution as an object having a mass and gradually attracting particles toward a better solution having a larger mass through gravitational attraction between the objects.

For example, the metaheuristic optimization algorithm may include problem-independent optimization frameworks applicable to various optimization problems without being limited to a specific problem domain, and may include algorithms effective in finding a global optimum by performing a balance between global search and local search.

For example, the robot calibration system 410 may be implemented and verified in a test environment shown in Table 1 below:

TABLE 1

| | |
|---|---|
| Category | Specification |

Robot Specifications

| Robot Model | BLS0509C | |
|---|---|---|
| Payload | 5 | kg |
| Reach | 917 | mm |
| Degrees of Freedom (DoF) | 6-axis | |
| Repeatability | ±0.02 | mm |

| | |
|---|---|
| Communication Interface | Ethernet, USB, Modbus, CAN |

Vision System Specifications

| | |
|---|---|
| Camera Model | Hikvision MV-CE060-10UM (Industrial |
| | Vision Camera) |
| Resolution | 3088 × 2064 pixels (6MP) |
| Lens Model | Computar M0814-MP2 (8 mm, F1.4, |
| | C-mount) |
| Lighting | High-intensity LED Ring Light (white, |
| | adjustable intensity) |
| Connectivity | USB 3.0 |

Environmental Conditions

| | |
|---|---|
| Operating Temperature | 15° C. to 40° C. |
| Humidity | 10% to 85% (non-condensing) |
| Lighting Conditions | Indoor laboratory lighting (controlled |
| | brightness environment) |
| Vibration | Minimal vibration (stationary mounting) |

Measurement Specifications

| Measurement Accuracy | ≤0.05 mm (Vision measurement | |
|---|---|---|
| | accuracy after calibration) | |
| Calibration Points | 10 fixed master points | |
| Distance to Reference Base | 2.5 | m |

Additional Experiment Conditions

| | |
|---|---|
| Calibration Algorithm | Self-adaptive metaheuristic optimization |
| | (ABC, PSO, DE, GSA) |
| Sampling Rate | 10 Hz (100 ms sampling interval) |
| Experiment Duration | Continuous operation for 4 hours |

In Table 1, a robot used in the robot calibration system 410 may be a BLS0509C model, may have a payload of 5 kg and a reach of 917 mm, and may have a multi-articulated structure with 6 degrees of freedom (6-axis). A repeatability may be at a level of ±0.02 mm, which may be suitable for a high-precision operation. A communication interface may support Ethernet, USB, Modbus, and CAN.

For example, the machine vision sensor may be implemented using a Hikvision MV-CE060-10UM industrial camera, and a resolution thereof may be 3088×2064 pixels (approximately 6 MP) to provide a high-resolution image. A lens may be a Computar M0814-MP2 (8 mm, F1.4, C-mount), and lighting may be implemented using a high-intensity LED ring light with adjustable intensity so as to minimize an effect of external illumination. Connection between the vision sensor and the system may be performed at a high speed through a USB 3.0 interface.

For example, an experiment for robot calibration may be performed in an indoor laboratory lighting environment within a temperature range of 15° C. to 40° C. and a humidity range of 10% to 85% (non-condensing), and the robot may be tested in a fixed installation state with minimal vibration.

For example, machine-vision-based measurement accuracy may be maintained at 0.05 mm or less after calibration, and calibration may be performed based on 10 fixed reference points (a marker or an object feature point). A distance between the robot and the reference points may be set to about 2.5 m or less.

For example, a self-correcting metaheuristic optimization technique may be applied as a calibration algorithm. A sampling rate may be set to 10 Hz (i.e., a sampling interval of 100 ms), and real-time position error may be measured and corrected during continuous operation for 4 hours.

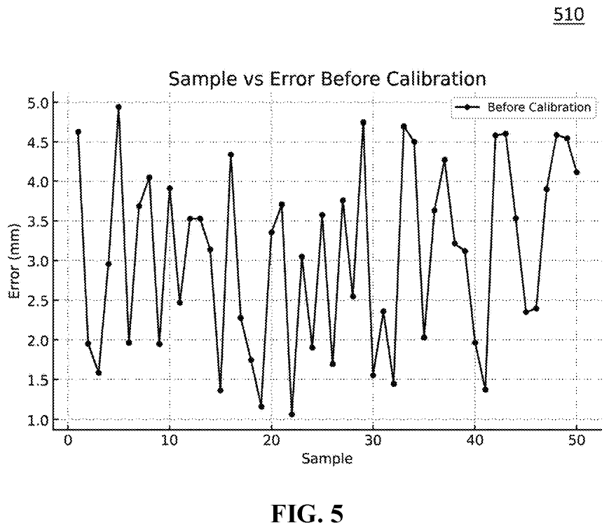

For example, the robot calibration system 410 may provide results as shown in Table 2 below. In addition, the results shown in Table 2 will be described later in detail with reference to FIGS. 5 to 8.

TABLE 2

| | | Error | | Error |
|---|---|---|---|---|
| Target | Position before | before | Position after | after |
| position | calibration | calibration | calibration | calibration |
| (x, y, z) | (x′, y′, z′) | (mm) | (x′, y′, z′) | (mm) |
| (349.82, 580.29, | (346.913, 577.175, | 4.633 | (349.7985, 580.2897, | 0.0216 |
| 492.8) | 490.981) | | 492.8003) | |
| (439.46, 262.41, | (440.492, 263.747, | 1.958 | (439.4405, 262.3943, | 0.0359 |
| 262.4) | 261.41) | | 262.3742) | |
| (223.23, 546.47, | (221.991, 545.492, | 1.58 | (223.2627, 546.4603, | 0.0362 |
| 440.45) | 440.393) | | 440.4379) | |
| (483.23, 208.23, | (485.607, 207.32, | 2.958 | (483.2686, 208.2244, | 0.0391 |
| 587.96) | 586.453) | | 587.9567) | |
| (532.98, 284.94, | (537.92, 285.024, | 4.943 | (533.0189, 284.9536, | 0.0418 |
| 272.73) | 272.863) | | 272.737) | |
| (273.36, 321.7, | (271.483, 321.912, | 1.968 | (273.3224, 321.6802, | 0.0493 |
| 409.9) | 410.454) | | 409.875) | |
| (372.78, 316.49, | (370.649, 316.005, | 3.689 | (372.7457, 316.4812, | 0.0355 |
| 444.74) | 441.769) | | 444.7374) | |
| (255.8, 316.86, | (254.847, 316.545, | 4.046 | (255.8277, 316.8681, | 0.0297 |
| 346.54) | 342.62) | | 346.533) | |
| (382.43, 514.07, | (381.54, 514.032, | 1.951 | (382.4726, 514.0612, | 0.0439 |
| 279.87) | 278.135) | | 279.8759) | |
| (405.69, 436.97, | (403.383, 435.125, | 3.913 | (405.6994, 436.994, | 0.0281 |
| 218.58) | 221.146) | | 218.5912) | |
| (443.02, 268.21, | (441.665, 270.089, | 2.471 | (443.0467, 268.2295, | 0.0332 |
| 226.02) | 226.88) | | 226.0222) | |
| (579.55, 586.25, | (582.485, 584.929, | 3.529 | (579.5685, 586.2449, | 0.0224 |
| 523.36) | 524.807) | | 523.3486) | |
| (321.85, 239.07, | (321.513, 239.203, | 3.534 | (321.8687, 239.0662, | 0.0208 |
| 473.69) | 477.206) | | 473.6981) | |
| (376.06, 248.82, | (379.158, 249.235, | 3.143 | (376.0874, 248.78, | 0.0489 |
| 398.07) | 397.74) | | 398.0641) | |
| (213.76, 563.73, | (214.82, 564.31, | 1.361 | (213.7778, 563.7382, | 0.0451 |
| 303.51) | 304.137) | | 303.4694) | |
| (465.01, 324.68, | (466.216, 328.85, | 4.341 | (465.0401, 324.6709, | 0.0409 |
| 408.03) | 408.099) | | 408.0039) | |
| (418.68, 273.94, | (416.658, 275.0, | 2.283 | (418.6578, 273.9232, | 0.0323 |
| 587.83) | 587.78) | | 587.8463) | |
| (510.05, 575.8, | (510.639, 575.517, | 1.746 | (510.0476, 575.7917, | 0.0252 |
| 557.93) | 556.311) | | 557.9537) | |
| (439.16, 568.75, | (438.937, 569.878, | 1.163 | (439.1551, 568.7607, | 0.0247 |
| 235.4) | 235.574) | | 235.4217) | |
| (278.39, 218.09, | (276.336, 216.912, | 3.364 | (278.3901, 218.0804, | 0.0275 |
| 330.13) | 327.741) | | 330.1558) | |
| (355.47, 308.54, | (358.924, 307.241, | 3.71 | (355.5064, 308.5419, | 0.0365 |
| 531.5) | 531.887) | | 531.4989) | |
| (342.7, 312.37, | (343.617, 312.743, | 1.066 | (342.6713, 312.3749, | 0.0414 |
| 417.08) | 416.684) | | 417.0506) | |
| (256.37, 520.88, | (259.404, 521.146, | 3.048 | (256.3485, 520.9104, | 0.0398 |
| 229.82) | 229.691) | | 229.8059) | |
| (594.75, 508.9, | (593.035, 509.713, | 1.906 | (594.7679, 508.9199, | 0.0284 |
| 279.49) | 279.317) | | 279.4805) | |
| (202.21, 526.18, | (205.698, 525.691, | 3.581 | (202.2103, 526.1786, | 0.0486 |
| 482.74) | 483.387) | | 482.7886) | |
| (491.6, 508.51, | (491.132, 507.285, | 1.697 | (491.6336, 508.5308, | 0.0421 |
| 229.62) | 230.698) | | 229.6054) | |
| (343.39, 246.35, | (345.624, 247.586, | 3.764 | (343.3534, 246.3494, | 0.0366 |
| 545.24) | 542.475) | | 545.2411) | |
| (449.32, 332.36, | (450.554, 330.272, | 2.547 | (449.3037, 332.3875, | 0.0384 |
| 225.42) | 224.642) | | 225.3988) | |
| (324.39, 330.07, | (328.76, 330.687, | 4.747 | (324.365, 330.0908, | 0.0326 |
| 491.84) | 493.588) | | 491.8414) | |
| (455.02, 554.89, | (453.618, 554.349, | 1.55 | (455.0427, 554.8771, | 0.0274 |
| 388.89) | 388.511) | | 388.8817) | |
| (247.84, 485.3, | (246.067, 483.739, | 2.364 | (247.8271, 485.3265, | 0.0307 |
| 504.31) | 504.408) | | 504.3014) | |
| (424.51, 508.39, | (425.436, 507.277, | 1.454 | (424.5507, 508.4017, | 0.0427 |
| 397.52) | 397.391) | | 397.5258) | |
| (409.09, 371.02, | (412.462, 371.21, | 4.699 | (409.0762, 371.0343, | 0.0204 |
| 210.17) | 213.437) | | 210.1652) | |
| (243.16, 212.57, | (241.686, 213.824, | 4.509 | (243.1537, 212.5593, | 0.0235 |
| 454.56) | 458.633) | | 454.5799) | |
| (325.74, 403.43, | (324.45, 403.005, | 2.032 | (325.73, 403.4297, | 0.0214 |
| 563.03) | 564.541) | | 563.0489) | |
| (299.72, 364.15, | (301.046, 362.9, | 3.64 | (299.7255, 364.1449, | 0.0212 |
| 502.22) | 505.371) | | 502.2399) | |
| (291.52, 230.79, | (294.385, 228.084, | 4.269 | (291.5584, 230.7653, | 0.0457 |
| 315.9) | 317.541) | | 315.9009) | |
| (264.49, 571.88, | (261.277, 572.109, | 3.221 | (264.5285, 571.8662, | 0.0411 |
| 523.25) | 523.252) | | 523.2455) | |
| (453.36, 548.58, | (454.292, 550.33, | 3.119 | (453.3281, 548.5894, | 0.0342 |
| 521.47) | 523.877) | | 521.462) | |
| (274.63, 557.02, | (274.045, 556.487, | 1.967 | (274.6164, 557.0337, | 0.0229 |
| 415.74) | 417.541) | | 415.7524) | |
| (522.98, 558.44, | (524.037, 558.899, | 1.372 | (523.0016, 558.442, | 0.0347 |
| 327.2) | 326.456) | | 327.1729) | |
| (244.02, 291.17, | (240.763, 293.855, | 4.589 | (243.9948, 291.1514, | 0.0342 |
| 370.84) | 372.64) | | 370.8263) | |
| (527.21, 544.29, | (523.154, 542.172, | 4.602 | (527.2318, 544.2861, | 0.0252 |
| 202.78) | 202.293) | | 202.7679) | |
| (404.3, 366.96, | (400.85, 366.229, | 3.532 | (404.3296, 366.9664, | 0.033 |
| 288.84) | 288.639) | | 288.8269) | |
| (247.95, 335.05, | (247.414, 333.119, | 2.356 | (247.9413, 335.0232, | 0.032 |
| 577.16) | 575.921) | | 577.145) | |
| (329.28, 407.52, | (331.633, 407.964, | 2.397 | (329.3131, 407.5395, | 0.0385 |
| 481.21) | 481.316) | | 481.2084) | |
| (345.45, 588.71, | (347.17, 590.947, | 3.904 | (345.4225, 588.6909, | 0.0391 |
| 584.98) | 582.282) | | 585.0001) | |
| (300.71, 398.9, | (303.912, 395.646, | 4.588 | (300.7182, 398.8814, | 0.0214 |
| 320.35) | 319.892) | | 320.3564) | |
| (313.94, 214.75, | (314.51, 213.788, | 4.548 | (313.9711, 214.7499, | 0.0312 |
| 443.83) | 439.421) | | 443.8327) | |
| (401.07, 220.59, | (398.119, 218.119, | 4.12 | (401.0424, 220.6135, | 0.0388 |
| 311.46) | 309.992) | | 311.4736) | |

FIG. 5 is a diagram illustrating a graph regarding a position error in controlling a position of an end effector based on a first DH parameter in a robot calibration system according to an embodiment of the present disclosure.

FIG. 5 is a graph 510 illustrating, for each sample, an error distribution between a target position and an actual reached position when an end effector of a robot is controlled based on an initial control parameter, that is, the first DH parameter, before application of the robot calibration system according to an embodiment of the present disclosure.

For example, an X-axis of the graph 510 indicates individual sample numbers used in an experiment, and each sample may indicate a different spatial position, that is, a task position to which the robot is set to reach. A Y-axis of the graph 510 indicates a position error at each sample, and may indicate, in millimeters (mm), a value calculated based on a Euclidean distance showing how far the robot actually deviates from the target position.

For example, as illustrated in FIG. 5, a position error of the robot before calibration may in some cases approach a maximum of 5 mm, and variation in errors among samples may also be large, from which it may be confirmed that precision of the robot is not constant. A state in which the DH parameter is not corrected may mean that the robot is unable to sufficiently secure repeatability or absolute positional accuracy in controlling a position, and may be a significant issue particularly in an application environment requiring a high-precision operation.

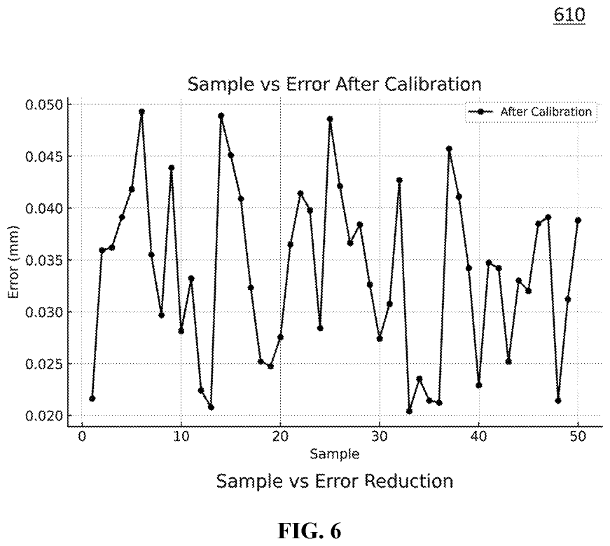

FIG. 6 is a diagram illustrating a graph regarding a position error in controlling a position of an end effector based on a second DH parameter in a robot calibration system according to an embodiment of the present disclosure.

FIG. 6 is a graph 610 illustrating, for each sample, a distribution of position errors when a position of an end effector of a robot is controlled after a second DH parameter, obtained by correcting a first DH parameter through the robot calibration system according to an embodiment of the present disclosure, is applied to a controller of the robot.

For example, an X-axis of the graph 610 indicates a total of 50 samples, that is, different task position points, and a Y-axis of the graph 610 indicates, in millimeters (mm), a position error measured at each sample. Each position error may be calculated based on the following Euclidean distance equation (e.g., Equation 1).

As illustrated in FIG. 6, after the DH parameter is updated through the metaheuristic-optimization-based real-time calibration algorithm of the present disclosure, a position error measured in all samples is maintained at a very low level between about 0.020 mm and about 0.050 mm. This represents a reduction of more than 100 times in the error compared with the maximum error before calibration shown in FIG. 5, which was about 5.0 mm, and may prove that the calibration system of the present disclosure is effective in improving absolute positional accuracy and precision of the robot.

In addition, the robot calibration system of the present disclosure may be described in that calibration is not merely one-time correction, but rather continuous correction of the DH parameter in real time while the robot is operating, thereby robustly responding even to a change in a work environment or a kinematic error. Further, FIG. 6 may explain that the robot calibration system of the present disclosure is a practical technology capable of stably maintaining positional precision of the robot based on a machine vision sensor without expensive external equipment such as a laser tracker or a coordinate measuring machine.

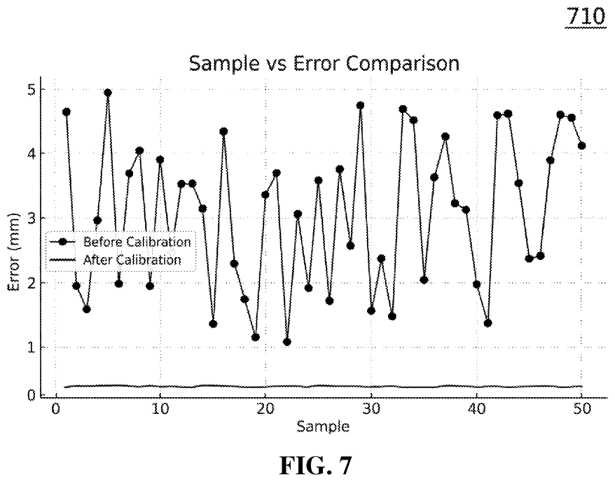

FIG. 7 is a diagram illustrating a graph regarding a difference between the position error illustrated in FIG. 5 and the position error illustrated in FIG. 6 in a robot calibration system according to an embodiment of the present disclosure.

FIG. 7 illustrates a comparison graph 710 in which the position error before calibration shown in FIG. 5 and the position error after calibration shown in FIG. 6 are presented together on a same-sample basis, in order to visually compare performance before and after application of the robot calibration system according to an embodiment of the present disclosure.

For example, an X-axis of the graph 710 indicates each sample number, and each sample may indicate an individual task position to which the robot is commanded to reach. A Y-axis of the graph 710 indicates a distance difference between a target position and an actual reached position of the robot, that is, a position error, in millimeters (mm).

FIG. 7 illustrates a first curve regarding a position error in control based on the first DH parameter (e.g., Before Calibration in FIG. 7), and a second curve regarding a position error in control based on the second DH parameter corrected through metaheuristic-based calibration (e.g., After Calibration in FIG. 7).

Referring to FIG. 7, the error before calibration reaches a maximum of about 5.0 mm, and variation in the error is also large depending on a sample. In contrast, the error after calibration is evenly distributed at about 0.02 mm to about 0.05 mm over an entire section, and consistently maintains a very low error level in all samples. Results of comparing the position error before and after calibration for each sample show that there are many cases in which a difference in the error reaches several millimeters (mm), and may be an indicator quantitatively proving an effect of application of the present disclosure.

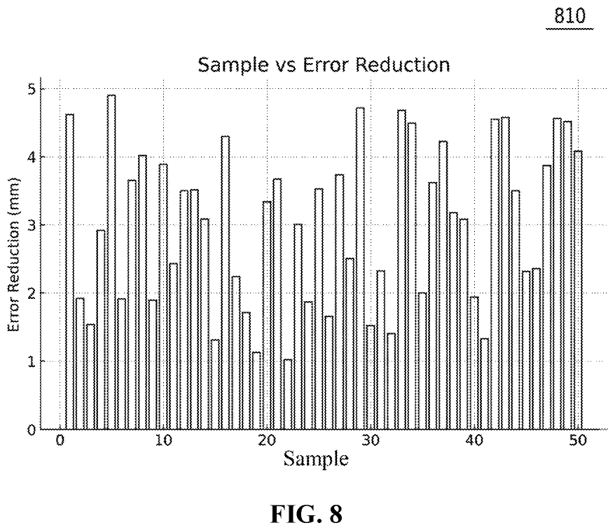

FIG. 8 is a diagram illustrating a graph regarding a reduction amount of a position error in controlling a position of an end effector based on a second DH parameter in a robot calibration system according to an embodiment of the present disclosure.

FIG. 8 is a bar graph 810 quantitatively showing, for each sample, whether a position error of the robot is reduced after application of the robot calibration system according to an embodiment of the present disclosure. The graph 810 illustrates, based on data obtained in FIG. 5, that is, the position error before calibration, and FIG. 6, that is, the position error after calibration, a reduction amount of the error calculated by Equation 3 below, that is, a value obtained by subtracting the error after calibration from the error before calibration for a same sample number.

$$Error {Reduction}_{i} = {e}_{i}^{before} - {e}_{i}^{after} \qquad [ Equation 3 ]$$

Here, [variable] may indicate a position error of an i-th sample before calibration, and [variable] may indicate a position error of an i-th sample after calibration.

For example, an X-axis of the graph 810 indicates each sample number, that is, a total of 50 samples, and a Y-axis of the graph 810 indicates, in millimeters (mm), a reduction amount of the error for each sample. As illustrated in FIG. 8, in most samples, the reduction amount of the error is 1 mm or more, and in some samples, a large improvement of 4 mm to 5 mm occurs, which may indicate that the calibration system of the present disclosure provides a substantial and consistent improvement effect on positional precision of the robot.

The above description is merely illustrative of the technical idea of the present disclosure, and various modifications and variations may be made by one of ordinary skill in the art to which the present disclosure belongs without departing from the essential characteristics of the present disclosure.

The embodiments described above may be implemented by hardware components, software components, and/or a combination of hardware components and software components. For example, devices, methods, and components described in the embodiments may be implemented using, for example, a general-purpose computer or a special-purpose computer, such as a processor, a controller, an arithmetic logic unit (ALU), a digital signal processor, a microcomputer, a field programmable gate array (FPGA), a programmable logic unit (PLU), a microprocessor, or any other device capable of executing an instruction and responding thereto. A processing device may execute an operating system (OS) and a software application executed on the operating system. In addition, the processing device may access, store, manipulate, process, and generate data in response to execution of software. Although one processing device is described as being used for convenience of understanding, one of ordinary skill in the art would understand that the processing device may include a plurality of processing elements and/or a plurality of types of processing elements. For example, the processing device may include a plurality of processors or one processor and one controller. In addition, another processing configuration, such as a parallel processor, is also possible.

Software may include a computer program, code, an instruction, or a combination of one or more thereof, and may configure a processing device to operate as desired or may instruct the processing device independently or collectively. The software and/or data may be permanently or temporarily embodied in any type of machine, component, physical device, virtual equipment, computer storage medium or device, or transmitted signal wave in order to be interpreted by the processing device or to provide an instruction or data to the processing device. The software may be distributed and stored or executed in a distributed manner on a computer system connected through a network. The software and data may be stored in a computer-readable recording medium.

A method according to an embodiment may be implemented in the form of program instructions executable by various computer means and may be recorded in a computer-readable medium. The computer-readable medium may include program instructions, data files, data structures, or a combination thereof. Program instructions recorded in the medium may be specially designed and configured for the embodiments or may be known and available to those skilled in the art of computer software. Examples of a computer-readable recording medium include magnetic media such as a hard disk, a floppy disk, and a magnetic tape, optical recording media such as a CD-ROM and a DVD, magneto-optical media such as a floptical disk, and hardware devices specially configured to store and execute program instructions, such as a ROM, a RAM, and a flash memory. Examples of program instructions include not only machine language code generated by a compiler but also high-level language code executable by a computer using an interpreter or the like.

The hardware devices described above may be configured to operate as one or more software modules in order to perform operations of the embodiments, and vice versa.

Although embodiments have been described above with reference to limited drawings, one of ordinary skill in the art may make various technical modifications and variations based thereon. For example, appropriate results may be achieved even if the described techniques are performed in a sequence different from the described methods, and/or components of the described systems, structures, devices, or circuits are combined or assembled in a form different from the described methods, or are substituted or replaced by other components or equivalents.

Accordingly, other implementations, other embodiments, and equivalents to the claims also fall within the scope of the claims set forth below. Therefore, the embodiments disclosed herein are intended to be illustrative rather than limiting of the technical idea of the present disclosure, and the scope of the technical idea of the present disclosure is not limited by these embodiments. The scope of protection of the present disclosure should be construed based on the claims below, and all technical ideas falling within the equivalent scope thereof should be construed as being included in the scope of the present disclosure.

### REFERENCE SIGNS LIST

100 robot calibration system
110 processor
120 memory
130 communication unit
140 machine vision sensor
150 error calculation unit
160 control unit
310 robot calibration system
410 robot calibration system
510 graph
610 graph
710 comparison graph
810 bar graph

What is claimed is:

1. A robot calibration system comprising a machine vision sensor connected to an end effector of a robot, a memory storing computer-executable instructions, and a processor configured to access the memory, execute the computer-executable instructions, and control the robot, the processor being configured to:
when a state of the robot is identified as performing a predetermined task, acquire, from the machine vision sensor, first position data regarding a task position required for the robot to perform the predetermined task; based on acquiring the first position data, acquire, from a controller controlling the robot, second position data regarding a position of the robot; determine a position error regarding an error between the first position data and the second position data; at a first time point at which the position error is determined, identify a first DH parameter (Denavit-Hartenberg parameter) regarding a positional relationship between a joint and a link of the end effector; apply the first DH parameter to a calibration model trained to minimize the position error, thereby acquiring a second DH parameter at a second time point subsequent to the first time point; and control a position of the end effector by applying the second DH parameter to the controller.

2. The system of claim 1, wherein the machine vision sensor is configured to determine the first position data based on a reference marker included in a space in which the robot performs the predetermined task or an external object that is a target of the predetermined task.

3. The system of claim 1, wherein the processor is configured to identify the first DH parameter based on at least one of a link length, a link twist, a joint offset, a joint angle, or a combination thereof.

4. The system of claim 1, wherein the processor is configured to identify a metaheuristic optimization algorithm including at least one of a Differential Evolution (DE) algorithm, a Particle Swarm Optimization (PSO) algorithm, an Artificial Bee Colony (ABC) algorithm, a Gravitational Search Algorithm (GSA), or a combination thereof, and perform training of the calibration model based on the metaheuristic optimization algorithm, an amount of change in the first DH parameter during a predetermined time interval, and a predetermined learning rate.

5. The system of claim 1, wherein the processor is configured to perform communication with the robot based on at least one of Ethernet, Universal Serial Bus (USB), Modbus, Controller Area Network (CAN) communication, or a combination thereof, acquire terrain information of a space in which the robot performs the predetermined task through a LiDAR sensor included in the robot, and perform verification of the first position data by applying the first position data acquired from the machine vision sensor to the terrain information acquired from the LiDAR sensor.
